(19) United States
(12) Patent Application Publication
(10) Pub. No.: US 2024/0007641 A1
(43) Pub. Date: Jan. 4, 2024

(54) Displaying Content in Electronic Devices with Gaze Detection

(71) Applicant: Apple Inc., Cupertino, CA (US)

(72) Inventors: Ada Y Chan, Cupertino, CA (US); Chelsea E Pugh, San Francisco, CA (US); Dean Jackson, Yass (AU); Timothy P Horton, Santa Clara, CA (US)

(21) Appl. No.: 18/330,249

(22) Filed: Jun. 6, 2023

Related U.S. Application Data
(63) Continuation of application No. 17/562,757, filed on Dec. 27, 2021, now Pat. No. 11,711,519.
Application No. 17/562,757 is a continuation of application No. PCT/KR2020/008233, filed on Jun. 24, 2020.
(60) Provisional application No. 62/865,951, filed on Jun. 24, 2019.

(51) Int. Cl. H04N 19/132; H04N 19/119; H04N 19/159; H04N 19/176; H04N 19/186

(52) U.S. Cl. CPC H04N 19/132; H04N 19/119; H04N 19/159; H04N 19/176; H04N 19/186

(57) ABSTRACT

An electronic device may include one or more sensors and one or more displays. The electronic device may receive content to be displayed on the one or more displays, information identifying a region of interest in the content, and an action associated with the region of interest from at least one external server. The electronic device may display the content. The electronic device may obtain, via the one or more sensors, a point of gaze and determine that the point of gaze overlaps the region of interest in the content. In accordance with the determination that the point of gaze overlaps the region of interest in the content, the electronic device may perform the action associated with the region of interest. The action may include providing visual, audio, and/or haptic feedback.

This application claims priority to U.S. provisional patent application No. 63/357,970, filed Jul. 1, 2022, which is hereby incorporated by reference herein in its entirety.

### BACKGROUND

This disclosure relates generally to electronic devices and, more particularly, to electronic devices with displays.

Some electronic devices include displays that present images close to a user's eyes. For example, extended reality headsets may include displays with optical elements that allow users to view images from the displays.

Devices such as these can be challenging to design. If care is not taken, it may be difficult for a user to provide user input.

### SUMMARY

An electronic device may include one or more sensors, one or more displays, one or more processors, and memory storing instructions configured to be executed by the one or more processors. The instructions may include instructions for receiving, from at least one external server, content to be displayed on the one or more displays, information identifying a region of interest in the content, and an action associated with the region of interest. The instructions may further include instructions for displaying, using the one or more displays, the content, obtaining, via the one or more sensors, a point of gaze, and in accordance with a determination that the point of gaze overlaps the region of interest in the content, performing the action associated with the region of interest.

### BRIEF DESCRIPTION OF THE DRAWINGS

FIG. 1 is a diagram of an illustrative system having a display in accordance with some embodiments.

FIG. 2A is a view of an illustrative display with multiple regions of interest in accordance with some embodiments.

FIG. 2B is a view of an illustrative display with a point of gaze overlapping a region of interest in accordance with some embodiments.

FIG. 2C is a view of an illustrative display showing how a region of interest may be highlighted in response to being overlapped by a point of gaze in accordance with some embodiments.

FIG. 2D is a view of an illustrative display showing how content in a region of interest may be enlarged in response to being overlapped by a point of gaze in accordance with some embodiments.

FIG. 2E is a view of an illustrative display showing how a region of interest may be outlined in response to being overlapped by a point of gaze in accordance with some embodiments.

FIG. 2F is a view of an illustrative display showing how content in a region of interest may be replaced with new content in response to being overlapped by a point of gaze in accordance with some embodiments.

FIG. 3 is a flowchart of an illustrative method performed by a system in accordance with some embodiments.

### DETAILED DESCRIPTION

Electronic devices such as two-dimensional displays and extended reality systems may include one or more gaze detection sensors configured to determine the point of gaze of a user. The user's point of gaze may be used to provide user input to the electronic device. For example, a user's point of gaze may serve as a cursor that selects a region of interest on a physical or virtual display. Point of gaze is a useful user input technique in extended reality systems with displays that present images close to a user's eyes (and touch input is therefore not practical).

However, care may be taken to minimize or eliminate the sharing of point of gaze information with external devices/servers (e.g., web pages that are being viewed on the electronic device). A web page may wish to display content that is responsive to point of gaze information. For example, looking at a thumbnail image on the web page may cause an enlarged version of the image or a text description of the image to appear. In one scenario, the electronic device could continuously provide point of gaze information to the web page to enable this functionality (e.g., the web page changes its content to include the enlarged version of the image when the point of gaze is aligned with the thumbnail image). However, a user may not want to share this information with a third party for privacy reasons. Alternatively, as will be shown and described herein, to mitigate or eliminate sending point of gaze information to the web page, the web page may identify (in advance) regions of interest in the web page content and actions corresponding to those regions of interest. In the example above, the web page may identify the thumbnail image as a region of interest and may also provide instructions for the electronic device to display the enlarged version of the image when the point of gaze overlaps the thumbnail image. Subsequently, when the point of gaze overlaps the thumbnail image, the electronic device may display the enlarged version of the image without needing to send point of gaze information to the web page or otherwise communicate with the web page. In this way, the desired user experience is achieved by the web page without the web page needing to receive any point of gaze information.

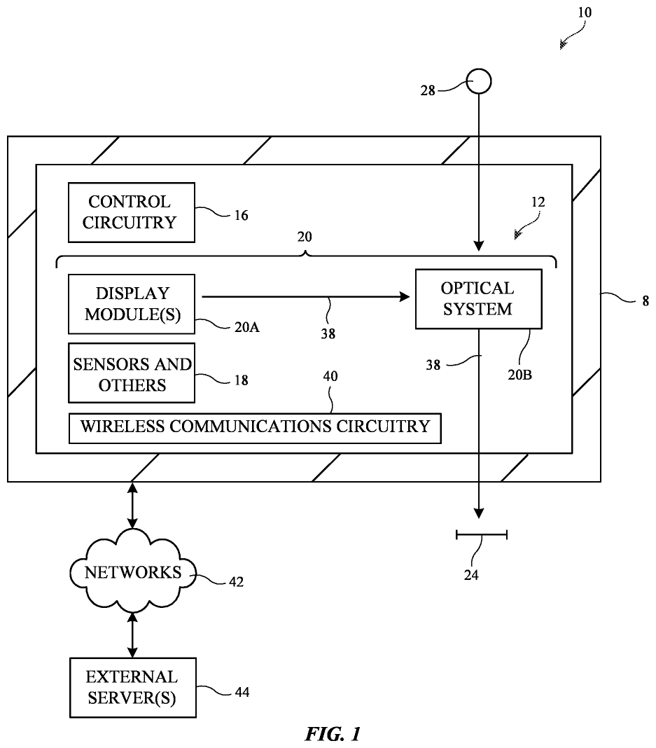

System 10 of FIG. 1 may be an electronic device (e.g., a head-mounted device) having one or more displays. The displays in system 10 may include displays 20 (sometimes referred to as near-eye displays) mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B. Display modules 20A may be mounted in a support structure such as support structure 8. Each display module 20A may emit light 38 (image light) that is redirected towards a user's eyes at eye box 24 using an associated one of optical systems 20B.

The example of system 10 being a head-mounted device is merely illustrative. In other possible arrangements, system 10 may be a cellular telephone, tablet computer, laptop computer, or other portable electronic device with a corresponding housing. In these scenarios, displays 20 may be displays having arrays of pixels and configured to display two-dimensional content (e.g., non-near-eye displays configured to be viewed at distances of greater than 10 centimeters).

The operation of system 10 may be controlled using control circuitry 16. Control circuitry 16 may be configured to perform operations in system 10 using hardware (e.g., dedicated hardware or circuitry), firmware and/or software. Software code for performing operations in system 10 and other data is stored on non-transitory computer readable storage media (e.g., tangible computer readable storage media) in control circuitry 16. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16. The processing circuitry may include application-specific integrated circuits with processing circuitry, one or more microprocessors, digital signal processors, graphics processing units, a central processing unit (CPU) or other processing circuitry.

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide system 10 with user input. Input-output devices 12 may also be used to gather information on the environment in which system 10 (e.g., a head-mounted device) is operating. Output components in devices 12 may allow system 10 to provide a user with output and may be used to communicate with external electrical equipment. Input-output devices 12 may include sensors and other components 18 (e.g., image sensors for gathering images of real-world objects that are optionally digitally merged with virtual objects on a display in system 10, image sensors for capturing images of a user's hands to identify hand gestures, accelerometers, depth sensors, light sensors, haptic output devices, speakers, batteries, etc.).

As a specific example, sensors 18 may include a gaze-tracker (sometimes referred to as a gaze-tracking system, gaze-tracking sensor, etc.). The gaze-tracker may include a camera and/or other gaze-tracking system components (e.g., light sources that emit beams of light so that reflections of the beams from a user's eyes may be detected) to monitor the user's eyes. One or more gaze-tracker(s) may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze.

Display modules 20A may be liquid crystal displays, organic light-emitting diode displays, laser-based displays, or displays of other types. Optical systems 20B may form lenses that allow a viewer (see, e.g., a viewer's eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly). Display modules that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

If desired, optical system 20B may contain components (e.g., an optical combiner, etc.) to allow real-world image light from real-world images or objects 28 to be combined optically with virtual (computer-generated) images such as virtual images in image light 38. In this type of system, a user of system 10 may view both real-world content and computer-generated content that is overlaid on top of the real-world content. Camera-based systems may also be used in system 10 (e.g., in an arrangement in which a camera captures real-world images of object 28 and this content is digitally merged with virtual content at optical system 20B).

System 10 may, if desired, include wireless circuitry (e.g., wireless communications circuitry 40) and/or other circuitry to support communications with a computer or other external equipment (e.g., a computer that supplies display 20 with image content, a server that provides web page information to system 10, etc.). During operation, control circuitry 16 may supply image content to display 20. The content may be remotely received (e.g., from a computer or other content source coupled to system 10 via wireless communications circuitry 40) and/or may be generated by control circuitry 16 (e.g., text, other computer-generated content, etc.). The content that is supplied to display 20 by control circuitry 16 may be viewed by a viewer at eye box 24.

Wireless communications circuitry 40 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 40 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a K a communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 40 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link antenna and another type of antenna may be used in forming a remote wireless link antenna.

During operation, electronic system 10 may communicate with one or more external servers 44 through network(s) 42. Examples of communication network(s) 42 include local area networks (LAN) and wide area networks (WAN) (e.g., the Internet). Communication network(s) 110 may be implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

External server(s) 44 may be implemented on one or more standalone data processing apparatus or a distributed network of computers. External server 44 may provide information such as web page content to system 10 (via network 42) in response to requests from system 10.

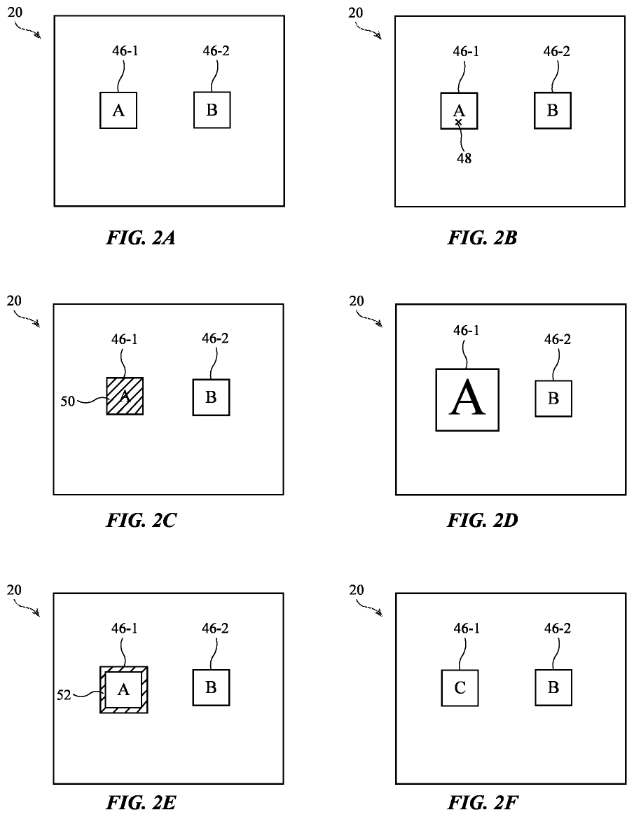

FIG. 2A is a view of an illustrative display 20 that presents images to a user. In particular, display 20 may present web page content (e.g., on a web browser that is displayed using system 10). The web page content may be received at system 10 from external server 44. In some head-mounted devices, system 10 may repeatedly transmit head pose information to external server 44. External server 44 may update the web page content based on the head pose information. This allows the web page content to be adjusted based on the head pose of the user, providing an interactive user experience.

As shown in FIG. 2A, the web page content may include one or more regions of interest 46. In FIG. 2A, the web page content includes a first region of interest 46-1 and a second region of interest 46-2. In this example, the content in the first region of interest 46-1 includes the letter A and the content in the second region of interest 46-2 includes the letter B.

Each region of interest on the web page may optionally be responsive to a user's point of gaze. In other words, the web page may perform an action in response to the user's point of gaze overlapping one of the regions of interest. In the example of FIG. 2B, point of gaze 48 overlaps region of interest 46-1. It may be desirable for a content update (or other action) to be performed in response to the point of gaze overlapping region of interest 46-1.

There are many possible actions that may be taken in response to the point of gaze overlapping a region of interest. FIG. 2C shows an example where the region of interest 46-1 overlapped by point of gaze 48 is visually highlighted (as indicated by highlight 50). The highlight may be a yellow highlight or highlight of another color with sufficient transparency to allow the underlying content to still be visible. FIG. 2D shows an example where the content in region of interest 46-1 is enlarged in response to the point of gaze overlapping region of interest 46-1 (e.g., the size of the ‘A’ in FIG. 2D is larger than in FIGS. 2A and 2B). FIG. 2E shows an example where an outline 52 is applied to region of interest 46-1 in response to the point of gaze overlapping region of interest 46-1. FIG. 2F shows an example where the content in region of interest 46-1 is changed (e.g., from ‘A’ to ‘C’) in response to the point of gaze overlapping region of interest 46-1. Although the content in region of interest 46-1 is changed in FIG. 2F, the content may instead be supplemented (e.g., additional content may be displayed adjacent to region of interest 46-1 in response to point of gaze overlapping region of interest 46-1).

To enable responsive regions of interest (as shown in FIGS. 2C-2F) while minimizing (or eliminating) transmission of point of gaze information from system 10 to external server 44, external server 44 may provide information regarding the regions of interest and actions corresponding to the regions of interest in parallel with the web page content.

It should be noted that there are multiple ways in which external server 44 may provide web page content to system 10. In a first example (e.g., according to the WebXR standard), external server 44 may (based on knowledge of the size of the display and/or the number of pixels in the display) provide a fully drawn scene to system 10. System 10 then displays the fully drawn scene using display 20. In a second example, external server 44 may provide HyperText Markup Language (HTML) documents (e.g., including one or more HTML elements) defining the web page to system 10. System 10 then renders the web page based on the received HTML documents received from the external server. In either example, system 10 may include a web rendering engine that is configured to provide web page content on display 20 based on information received from external server 44.

When the external server provides the web page content according to the first example, external server 44 may identify regions of interest on the display in parallel with providing the fully drawn scene to system 10. For example, the external server may identify a subset of the display corresponding to region 46-1 as a first region of interest. The external server may, in parallel, provide an action that is associated with the first region of interest.

When the external server provides the web page content according to the second example, external server 44 may identify regions of interest on the display in parallel with providing the HTML documents to system 10. If desired, specific HTML elements may be identified as the regions of interest. For example, the external server may identify a first HTML element corresponding to region 46-1 as a first region of interest. The external server may, in parallel, provide an action that is associated with the first region of interest.

To achieve the highlighting effect of FIG. 2C, the external server may provide an action that instructs the system to highlight the region of interest if the region of interest is overlapped by the point of gaze. Thereafter, when the user is interacting with the web page, the region of interest is highlighted by the system when overlapped by the point of gaze (without needing to send any information to the external server to prompt the effect).

To achieve the enlarging effect of FIG. 2D, the external server may provide an action that instructs the system to enlarge content in the region of interest if the region of interest is overlapped by the point of gaze. Thereafter, when the user is interacting with the web page, the region of interest is enlarged by the system when overlapped by the point of gaze (without needing to send any information to the external server to prompt the effect).

To achieve the outline effect of FIG. 2E, the external server may provide an action that instructs the system to outline the region of interest if the region of interest is overlapped by the point of gaze. Thereafter, when the user is interacting with the web page, the region of interest is outlined by the system when overlapped by the point of gaze (without needing to send any information to the external server to prompt the effect).

To achieve the content replacement effect of FIG. 2F, the external server may provide an action that instructs the system to replace the content in the region of interest if the region of interest is overlapped by the point of gaze. The external server may provide the replacement content to be used in the event of the replacement being triggered. Thereafter, when the user is interacting with the web page, the region of interest is replaced with new content by the system when overlapped by the point of gaze (without needing to send any information to the external server to prompt the effect).

This technique of receiving gaze-based content response instructions in advance reduces latency (since the system does not have to wait for instructions from the external server to achieve the desired effect) and eliminates the need to provide point of gaze information to external server 44.

As previously mentioned, the regions of interest in the displayed content may be identified by external server 44 using one or more HTML elements. Alternatively, the regions of interest in the displayed content may be identified by external server 44 as a subset of the display. For example, the external server may provide a range of pixel coordinates that correspond to the region of interest. As a specific example, the external server may define a region of interest as a box with an upper left corner at pixel (30, 30) (e.g., row 30 and column 30) and a lower right corner at pixel (60, 60) (e.g., row 60 and column 60).

The location and presence of each region of interest is decoupled from the type of content displayed in that region of interest. In other words, external server 44 may define any number of regions of interest at any desired portions of the display. Each region of interest may include any desired type of display content. The region of interest may include two-dimensional content or three-dimensional content (in embodiments where device 10 includes a stereoscopic display capable of displaying three-dimensional content). The region of interest may have the appearance of a button, may be a thumbnail image, may correspond to a game object or other piece of content on the web page, etc. Alternatively, the region of interest may not align with any content boundaries in the web page content. For example, a subset of a white background may define a hidden region of interest for a hidden effect that may be discovered via point of gaze overlap (e.g., in a game application). In general, external server 44 may assign regions of interest to any desired portion of the web page content provided to system 10.

Control circuitry 16 may query the external server 44 for information identifying the regions of interest and actions associated with the regions of interest. Alternatively, external server 44 may automatically transmit information identifying the regions of interest and actions associated with the regions of interest to device 10 at some frequency.

There are a wide variety of actions that may be associated with the regions of interest. The actions may include visual actions (feedback) as illustrated in FIGS. 2C-2F (e.g., highlighting the region of interest, enlarging content in the region of interest, outlining the region of interest, changing the content in the region of interest, etc.). The visual actions may include instructions for system 10 to display an overlay in response to the region of interest being overlapped by the point of gaze. The external server 44 may provide an image to use as the overlay. Instead or in addition, system 10 may store various predetermined overlay images or overlay effects (e.g., outlines, highlights, etc.) and external server 44 may identify one of the predetermined overlay effects when providing the action for a region of interest.

When an action for a region of interest includes overlaying an image, the overlayed image may be overlayed over the region of interest (e.g., as in FIG. 2F) or elsewhere on the display (e.g., not overlapping the region of interest). For example, a point of gaze overlapping region of interest 46-1 may trigger an image to be overlayed on region of interest 46-2 if desired. Alternatively, a point of gaze overlapping region of interest 46-1 may trigger an image to be overlayed adjacent to but not overlapping region of interest 46-1 (e.g., to display a text description of the content in region 46-1 without overlapping the content in region 46-1).

The actions associated with a region of interest are not limited to visual effects as shown in FIGS. 2C-2F. In general, the action associated with a region of interest may include output from any output component in device 10. For example, external server 44 may provide instructions for device 10 to play audio (e.g., a song, sound effect, etc.) using a speaker in response to a region of interest being overlapped by the point of gaze. External server 44 may provide instructions for device 10 to provide haptic feedback using a haptic feedback component in response to a region of interest being overlapped by the point of gaze.

Additionally, each region of interest may have multiple associated actions if desired. For example, external server 44 may provide instructions for device 10 to provide visual, audio, and haptic feedback in response to a region of interest being overlapped by the point of gaze.

External server 44 may also provide instructions regarding the user behavior that triggers the action associated with a region of interest. The example has been described herein where the action is triggered based on a point of gaze overlapping the region of interest. The external server 44 may instead specify that the action is triggered based on a point of gaze overlapping the region of interest for at least a given dwell time (e.g., at least 100 milliseconds, at least 200 milliseconds, at least 1 second, etc.).

As yet another example, the external server 44 may specify that the action associated with a region of interest is triggered based on a combination of point of gaze input (e.g., the point of gaze overlapping the region of interest) and other user input. The other user input may be obtained using any desired input components in device 10 (e.g., using sensors 18 in FIG. 1). For example, a touch sensor in device 10 may gather touch input, a microphone in device 10 may gather audio input, a button in device 10 may gather user input, a camera in device 10 may identify hand gestures performed by the user, an accelerometer in device 10 may identify user movements as input, etc. The external server 44 may specify that the action associated with a region of interest is triggered based on a combination of point of gaze input, touch sensor input, audio input, hand gestures obtained via a camera, user movement, and/or input via a button.

External server 44 may send content to be displayed on system 10 at a first frequency (e.g., every frame). The external server 44 may send the information identifying regions of interest and the actions associated with the regions of interest at a second frequency that is equal to the first frequency or less than the first frequency. In other words, the external server 44 may send the information identifying regions of interest and the actions associated with the regions of interest in parallel with every frame or less frequently than every frame (e.g., once every two frames, once every four frames, once every ten frames, etc.). System 10 may transmit head pose information to external server 44 at a third frequency that is equal to the first frequency (e.g., every frame) or less than the first frequency (e.g., once every two frames, once every four frames, once every ten frames, etc.).

System 10 may transmit point of gaze information to external server 44 in some scenarios. For example, if a user of system 10 authorizes the sharing of point of gaze information, the system may send point of gaze information to the external server when the point of gaze overlaps the region of interest at the same time as a user selection input (e.g., user input that serves as a click for the web page) is received or the system may send point of gaze information to the external server when the point of gaze overlaps the region of interest. The system may not send information regarding the point of gaze to the at least one external server when the point of gaze does not overlap the region of interest. In some scenarios, the system does not send information regarding the point of gaze to the at least one external server regardless of whether the point of gaze overlaps the region of interest or the point of gaze does not overlap the region of interest.

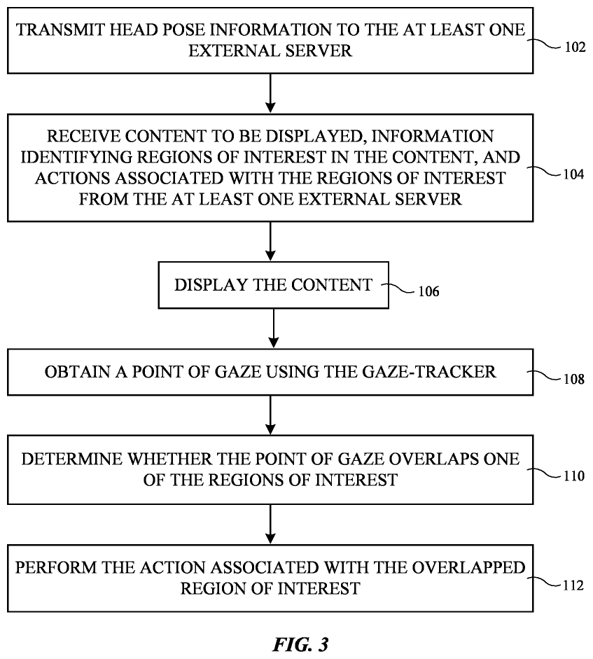

FIG. 3 is a flowchart showing an illustrative method performed by a system (e.g., control circuitry 16 in system 10). The blocks of FIG. 3 may be stored as instructions in memory of system 10, with the instructions configured to be executed by one or more processors in the system.

At block 102, the control circuitry may transmit head pose information to at least one external server 44. The head pose information may be transmitted to external server 44 via network 42. The at least one external server may be an external server for a web page that is being viewed by a user of system 10. The head pose information may be used by external server 44 to update the web page content, providing an interactive user experience.

At block 104, the control circuitry may receive, from the at least one external server 44, content to be displayed on display 20 in device 10. In addition, the control circuitry may receive information identifying regions of interest in the content and actions associated with the regions of interest from the at least one external server. The content, information identifying regions of interest in the content, and actions associated with the regions of interest may be received from external server 44 via network 42.

The regions of interest may be identified by external server 44 using pixel coordinates, HTML elements, or other desired identification information. Each region of interest may have one or more associated actions. The one or more associated actions include feedback (e.g., visual, audio, and/or haptic feedback) that is triggered by user input to the device. For example, each action may be represented by a conditional statement. Exemplary conditional statements provided by the external server 44 at block 104 include “if the point of gaze of the user overlaps a region of interest, highlight that region of interest,” “if the point of gaze of the user overlaps a region of interest, play a sound effect,” and “if the point of gaze of the user overlaps a region of interest for at least 200 milliseconds, play a sound effect and outline the region of interest.”

Consider the example shown in FIGS. 2B and 2C. At block 104, the external server 44 may transmit to system 10 content for the display (e.g., including ‘A’ in region 46-1 and ‘B’ in region 46-2), information identifying region of interest 46-1 (that includes the ‘A’) and region of interest 46-2 (that includes the ‘B’), and actions associated with each region of interest (e.g., highlight region 46-1 if the point of gaze overlaps region 46-1 and outline region 46-2 if the point of gaze overlaps region 46-2).

At block 106, control circuitry 16 may display the content received from the external server. Control circuitry 16 may display the content using a web rendering engine, as one example. Continuing the example above, the control circuitry may display ‘A’ in region 46-1 and ‘B’ in region 46-2 based on the content received from the external server.

At block 108, a gaze-tracker (e.g., of the sensors 18 in FIG. 1) may be used to obtain a point of gaze of the user of system 10. At block 110, control circuitry 16 may determine whether the point of gaze overlaps one of the regions of interest received from external server 44. In the example above, control circuitry 16 may determine whether the point of gaze overlaps region of interest 46-1 or region of interest 46-2 (which are defined using information received from the external server). This example assumes that the actions associated with the regions of interest are to be performed when the point of gaze overlaps that region of interest. However, additional conditions may be tied to the actions (e.g., a required dwell time to trigger the action, additional non-gaze user input to trigger the action, etc.).

If the point of gaze overlaps one of the regions of interest (and other conditions required to trigger the action for the given region of interest are met, if applicable), the control circuitry may perform the action associated with the overlapped region of interest in block 112. The action may include feedback (output) provided using any output components in the system. For example, the action may include providing visual feedback (e.g., highlighting the region of interest as in FIG. 2C, enlarging the content in the region of interest as in FIG. 2D, outlining the region of interest as in FIG. 2E, changing the content in the region of interest as in FIG. 2F, etc.), providing audio feedback (e.g., playing a song or sound effect) and/or providing haptic feedback. The action at block 112 may be performed without system 10 transmitting the point of gaze to the external server.

Using the example above, control circuitry 16 may highlight region 46-1 at block 112 if the point of gaze overlaps region 46-1. Alternatively, control circuitry 16 may outline region 46-2 at block 112 if the point of gaze overlaps region 46-2.

In stereoscopic displays capable of displaying three-dimensional images, the content received at block 104, the regions of interest in the content (identified in block 104), and/or overlay content applied at block 112 may all optionally be three-dimensional images.

The method illustrated in FIG. 3 advantageously allows a system to present interactive content while maintaining the user's privacy. In particular, the user's gaze information may be processed locally at the system to cause an appropriate response in the content. The gaze information need not be transmitted to an external electronic device or server, thereby preserving the user's privacy.

As described above, one aspect of the present technology is the gathering and use of information such as sensor information. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. An electronic device comprising:
one or more sensors;
one or more displays;
one or more processors; and
memory storing instructions configured to be executed by the one or more processors, the instructions for:
receiving, from at least one external server:
content to be displayed on the one or more displays;
information identifying a region of interest in the content; and
an action associated with the region of interest;
displaying, using the one or more displays, the content;
obtaining, via the one or more sensors, a point of gaze; and
in accordance with a determination that the point of gaze overlaps the region of interest in the content, performing the action associated with the region of interest.

2. The electronic device defined in claim 1, wherein determining that the point of gaze overlaps the region of interest comprises determining that the point of gaze overlaps the region of interest after receiving the content to be displayed on the one or more displays, the information identifying the region of interest in the content, and the action associated with the region of interest.

3. The electronic device defined in claim 1, wherein the information identifying the region of interest in the content identifies a plurality of regions of interest in the content and wherein receiving the action associated with the region of interest comprises receiving a plurality of actions, each action being associated with a respective region of interest of the plurality of regions of interest.

4. The electronic device defined in claim 1, wherein performing the action associated with the region of interest comprises:
visually highlighting, via the one or more displays, the region of interest;
enlarging content in the region of interest;
playing audio via one or more speakers; or
displaying, via the one or more displays, an overlay over the content.

5. The electronic device defined in claim 1, wherein the instructions further comprise instructions for:
in accordance with detecting a user selection input while the point of gaze overlaps the region of interest, sending information to the at least one external server; and
in accordance with detecting an absence of the user selection input while the point of gaze overlaps the region of interest, forgoing sending information regarding the point of gaze to the at least one external server.

6. The electronic device defined in claim 1, wherein the content represents a web page.

7. The electronic device defined in claim 1, wherein the instructions further comprise instructions for:
repeatedly transmitting head pose information to the at least one external server at a first frequency, wherein receiving, from the at least one external server, the content, the information identifying the region of interest in the content, and the action associated with the region of interest comprises:
repeatedly receiving at a second frequency, from the at least one external server, the content, the information identifying the region of interest in the content, and the action associated with the region of interest.

8. The electronic device defined in claim 1, wherein the instructions further comprise instructions for:
obtaining, via the one or more sensors, additional user input, wherein performing the action associated with the region of interest comprises:
based on the additional user input and in accordance with the determination that the point of gaze overlaps the region of interest in the content, performing the action associated with the region of interest, wherein the additional user input comprises touch sensor input, audio input, user input to a button, hand gesture input, or input obtained using an accelerometer.

9. A method of operating an electronic device that comprises one or more sensors and one or more displays, the method comprising:
receiving, from at least one external server:
content to be displayed on the one or more displays;
information identifying a region of interest in the content; and
an action associated with the region of interest;
displaying, using the one or more displays, the content;
obtaining, via the one or more sensors, a point of gaze; and
in accordance with a determination that the point of gaze overlaps the region of interest in the content, performing the action associated with the region of interest.

10. The method defined in claim 9, wherein determining that the point of gaze overlaps the region of interest comprises determining that the point of gaze overlaps the region of interest after receiving the content to be displayed on the one or more displays, the information identifying the region of interest in the content, and the action associated with the region of interest.

11. The method defined in claim 9, wherein the information identifying the region of interest in the content identifies a plurality of regions of interest in the content and wherein receiving the action associated with the region of interest comprises receiving a plurality of actions, each action being associated with a respective region of interest of the plurality of regions of interest.

12. The method defined in claim 9, wherein performing the action associated with the region of interest comprises:
visually highlighting, via the one or more displays, the region of interest;
enlarging content in the region of interest;
playing audio via one or more speakers; or
displaying, via the one or more displays, an overlay over the content.

13. The method defined in claim 9, further comprising:
in accordance with detecting a user selection input while the point of gaze overlaps the region of interest, sending information to the at least one external server; and
in accordance with detecting an absence of the user selection input while the point of gaze overlaps the region of interest, forgoing sending information regarding the point of gaze to the at least one external server.

14. The method defined in claim 9, wherein the content represents a web page.

15. The method defined in claim 9, further comprising:
repeatedly transmitting head pose information to the at least one external server at a first frequency, wherein receiving, from the at least one external server, the content, the information identifying the region of interest in the content, and the action associated with the region of interest comprises:
repeatedly receiving at a second frequency, from the at least one external server, the content, the information identifying the region of interest in the content, and the action associated with the region of interest.

16. The method defined in claim 9, further comprising:
obtaining, via the one or more sensors, additional user input, wherein performing the action associated with the region of interest comprises:
based on the additional user input and in accordance with the determination that the point of gaze overlaps the region of interest in the content, performing the action associated with the region of interest, wherein the additional user input comprises touch sensor input, audio input, user input to a button, hand gesture input, or input obtained using an accelerometer.

17. A non-transitory computer-readable storage medium storing one or more programs configured to be executed by one or more processors of an electronic device that comprises one or more sensors and one or more displays, the one or more programs including instructions for:
receiving, from at least one external server:
content to be displayed on the one or more displays;
information identifying a region of interest in the content; and
an action associated with the region of interest;
displaying, using the one or more displays, the content;
obtaining, via the one or more sensors, a point of gaze; and
in accordance with a determination that the point of gaze overlaps the region of interest in the content, performing the action associated with the region of interest.

18. The non-transitory computer-readable storage medium defined in claim 17, wherein determining that the point of gaze overlaps the region of interest comprises determining that the point of gaze overlaps the region of interest after receiving the content to be displayed on the one or more displays, the information identifying the region of interest in the content, and the action associated with the region of interest.

19. The non-transitory computer-readable storage medium defined in claim 17, wherein the information identifying the region of interest in the content identifies a plurality of regions of interest in the content and wherein receiving the action associated with the region of interest comprises receiving a plurality of actions, each action being associated with a respective region of interest of the plurality of regions of interest.

20. The non-transitory computer-readable storage medium defined in claim 17, wherein performing the action associated with the region of interest comprises:
visually highlighting, via the one or more displays, the region of interest;
enlarging content in the region of interest;
playing audio via one or more speakers; or
displaying, via the one or more displays, an overlay over the content.

21. The non-transitory computer-readable storage medium defined in claim 17, wherein the instructions further comprise instructions for:
in accordance with detecting a user selection input while the point of gaze overlaps the region of interest, sending information to the at least one external server; and
in accordance with detecting an absence of the user selection input while the point of gaze overlaps the region of interest, forgoing sending information regarding the point of gaze to the at least one external server.

22. The non-transitory computer-readable storage medium defined in claim 17, wherein the content represents a web page.

23. The non-transitory computer-readable storage medium defined in claim 17, wherein the instructions further comprise instructions for:
repeatedly transmitting head pose information to the at least one external server at a first frequency, wherein receiving, from the at least one external server, the content, the information identifying the region of interest in the content, and the action associated with the region of interest comprises:
repeatedly receiving at a second frequency, from the at least one external server, the content, the information identifying the region of interest in the content, and the action associated with the region of interest.

24. The non-transitory computer-readable storage medium defined in claim 17, wherein the instructions further comprise instructions for:
obtaining, via the one or more sensors, additional user input, wherein performing the action associated with the region of interest comprises:
based on the additional user input and in accordance with the determination that the point of gaze overlaps the region of interest in the content, performing the action associated with the region of interest, wherein the additional user input comprises touch sensor input, audio input, user input to a button, hand gesture input, or input obtained using an accelerometer.
